(19) United States
(12) Patent Application Publication
(10) Pub. No.: US 2008/0107091 A1
(43) Pub. Date: May 8, 2008

(54) BROADCAST EFFICIENCY IN A MULTIHOP NETWORK

(75) Inventor: Shyamal Ramachandran, Heathrow, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Plantation, FL (US)

(21) Appl. No.: 11/557,426

(22) Filed: Nov. 7, 2006

(51) Int. Cl. H04Q 7/24

(52) U.S. Cl. 370/338; 375/211; 455/436

(57) ABSTRACT

Techniques are provided for improving broadcast efficiency in a multihop network having a base station which transmits a downlink signal, at least one relay station and at least one node associated with the relay station. The relay station relays or retransmits the downlink signal it receives from the base station to nodes associated with the relay station. The base station monitors downlink transmission metrics provided by each of the nodes associated with the relay station. Each downlink transmission metric provides a measure of the downlink signal received by a particular node from the base station. Based on the downlink transmission metrics, the base station can decide if the relay station should continue to relay or retransmit the downlink signal to the nodes associated with the relay station.

### FIELD OF THE INVENTION

The present invention relates generally to wireless communications and more particularly to multihop communication networks which utilize relay stations to facilitate communication between a base station and one or more nodes.

### BACKGROUND

An infrastructure-based wireless network typically includes a communication network with fixed and wired gateways. Many infrastructure-based wireless networks employ a mobile unit which communicates with a fixed base station that is coupled to a wired network. The mobile unit can move geographically while it is communicating over a wireless link to the base station. When the mobile unit moves out of range of one base station, it may connect or “handover” to a new base station and starts communicating with the wired network through the new base station.

In comparison to infrastructure-based wireless networks, an ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network. Links or connections between these nodes can change dynamically in an arbitrary manner as existing nodes move within the ad hoc network, as new nodes join or enter the ad hoc network, or as existing nodes leave or exit the ad hoc network. Because the topology of an ad hoc network can change significantly techniques are needed which can allow the ad hoc network to dynamically adjust to these changes. Due to the lack of a central controller, many network-controlling functions can be distributed among the nodes such that the nodes can self-organize and reconfigure in response to topology changes.

One characteristic of the nodes is that each node can directly communicate over a short range with nodes which are a single “hop” away. Such nodes are sometimes referred to as “neighbor nodes.” When a node transmits packets to a destination node and the nodes are separated by more than one hop (e.g., the distance between two nodes exceeds the radio transmission range of the nodes, or a physical barrier is present between the nodes), the packets can be relayed via intermediate nodes (“multihopping”) until the packets reach the destination node. As used herein, the term “multihop network” refers to any type of wireless network which employs routing protocols among nodes which are part of a network. In such situations, each intermediate node routes the packets (e.g., data and control information) to the next node along the route, until the packets reach their final destination

The Institute of Electrical and Electronics Engineers (IEEE) 802.16 Working Group on Broadband Wireless Access Standards aims to prepare formal specifications for the global deployment of broadband Wireless Metropolitan Area Networks. Among other things, the 802.16 standards define a point-to-multipoint (PMP) system with one hop links between a base station and a subscriber station. Such network topologies sometimes include pockets of poor-coverage areas. While such coverage voids can be avoided by deploying base stations tightly, this drastically increases both the capital expenditure (CAPEX) and operational expenditure (OPEX) for the network deployment. A cheaper solution is to deploy relay stations (also known as relays or repeaters) in the areas with poor coverage. These relay stations can repeat transmissions from the base station so that subscriber stations within communication range of a relay station can continue to communicate with the base station using high data rate links. The incorporation of relay stations in an IEEE 802.16 network transforms it into a multihop network with each node having one or more options to access a network, such as the Internet, via a base station.

For example, networks which comply with the IEEE 802.16j specifications will employ relay stations in an IEEE 802.16e network to provide for range extension and capacity improvements. Depending upon the particular network configuration, a particular subscriber station may gain network access via one or more neighbor relay stations and/or one or more neighbor base stations. In addition, relay stations themselves might have one or more available path options to connect to a particular base station. The relay stations can be implemented such that they are fixed, stationary, nomadic or mobile. The IEEE 802.16j standard requires that the air interface link between a relay station and a subscriber station appears to be exactly like the air interface between the base station and the subscriber station. From the perspective of the subscriber station any communications with the base station which are relayed through the relay station appear to be the same as if they had come directly from the base station.

### BRIEF DESCRIPTION OF THE FIGURES

The accompanying figures, which together with the detailed description below are incorporated in and form part of the specification, serve to further illustrate various embodiments and to explain various principles and advantages all in accordance with the present invention.

FIG. 1 illustrates an exemplary wireless communication network for use in an exemplary implementation of the present invention;

FIG. 2 illustrates an exemplary base station in accordance with some embodiments of the present invention;

FIG. 3 illustrates an exemplary relay station in accordance with some embodiments of the present invention;

FIG. 4 is a block diagram of an exemplary communication network which comprises a plurality of multihop cells (MHCs) and a mobile relay station (MRS);

FIG. 5 is a flowchart showing an exemplary method for improving broadcast efficiency in a multihop network in accordance with some embodiments of the invention;

FIG. 6 is a flowchart showing an exemplary method for operating a base station within the multihop network to improve broadcast efficiency in the multihop network in accordance with some embodiments of the invention

FIG. 7 is a flowchart showing an exemplary method for operating a relay station within the multihop network to generate a downlink report in accordance with some embodiments of the invention;

FIG. 8 is a flowchart showing an exemplary method for operating a base station and a passive relay station within the multihop network in accordance with some embodiments of the invention;

FIG. 9 is a block diagram of an exemplary communication network which illustrates a coverage footprint of a base station operating at a first frequency and coverage footprints of relay stations which are within the coverage footprint of a base station and operating a second frequency; and

FIG. 10 is a block diagram of an exemplary communication network which illustrates a coverage footprint of a base station operating at a first frequency and coverage footprints of relay stations which are within the coverage footprint of a base station and also operating at the first frequency.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to techniques for improving broadcast efficiency in a multihop network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions for improving broadcast efficiency in a multihop network as described herein. The non-processor circuits may include, but are not limited to, a radio receiver, a radio transmitter, signal drivers, clock circuits, power source circuits, and user input devices. As such, these functions may be interpreted as steps of a method for improving broadcast efficiency in a multihop network by reducing the amount of traffic. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily designed to allow generating such software instructions and programs and ICs with minimal experimentation.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

### Exemplary Network

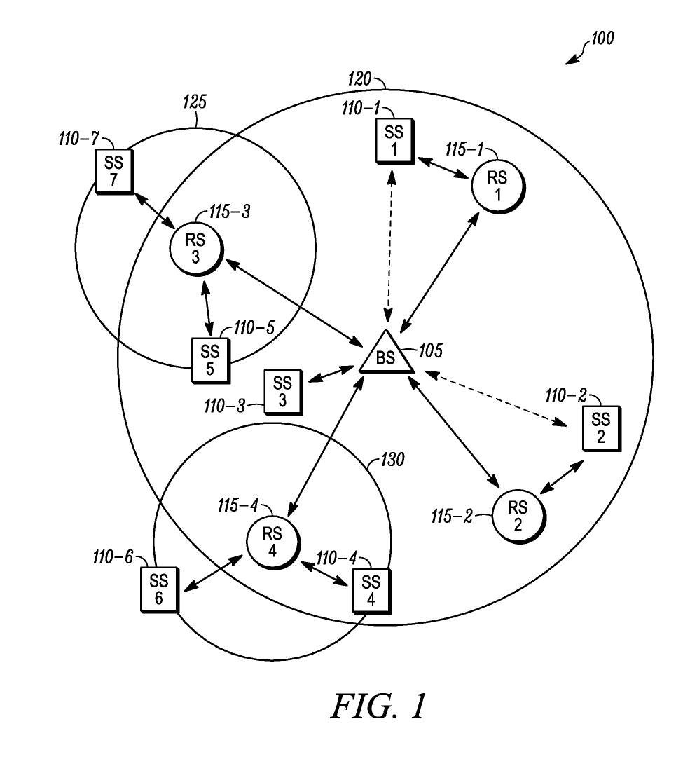

FIG. 1 illustrates an exemplary wireless communication network 100 for use in an exemplary implementation of the present invention. The network 100 is capable of operating in compliance with the IEEE 802.16 standards. As illustrated, the network 100 includes a plurality of subscriber stations 110-n, a plurality of relay stations 115-n, and at least one base station 105. The base station 105 can communicate with plurality of subscriber stations 110-n either directly or indirectly through the relay stations 1 115-n.

To provide greater control over the network many decisions are made at the base station 105. For example, centralized routing and scheduling algorithms can be implemented within the base station 105, and the base station 105 can be responsible for making routing decisions for the different multihop network entities. The base station 105 can also be responsible for frame time allocations to nodes (e.g., relay stations (RSs) and subscriber stations (SSs) within operating range of the base station (e.g., in the base station's “multihop cell”).

The relay stations 115-n (also known as repeaters) are used to provide coverage and capacity gains by extending the base station's 105 range and permitting subscriber stations 110-n to multihop their communications (e.g., user data and/or control information) to and from the base station 105. The relay stations 115-n can be deployed, for example, in the areas with poor coverage and repeat transmissions so that subscriber stations 110-n in a cell boundary can connect using high data rate links. In some cases relays 115-n may also serve subscriber stations 110-n that are out of the coverage range of the base station 105. In some networks, the relays 115-n are simpler versions of the base station 105, in that they do not manage connections, but only assist in relaying data. Alternatively, the relays 115-n can be at least as complex as the base station 105.

As illustrated in FIG. 1, the relay stations 115-n of the network 100 can provide communication coverage outside the base station coverage area 120. Subscriber stations SS6 110-6 and SS7 110-7 are out of the coverage range of the base station 105. Since subscriber station 6 110-6 and subscriber station 7 110-7 cannot be controlled by the base station 105 directly, they are controlled by the relay stations 115-4 and 115-3 respectively, or by the base station 105 through the relay stations 115-4 and 115-3 respectively.

For example, a relay station 3 115-3 provides a coverage area 125 and a relay station 4 115-4 provides a coverage area 130 which include communication coverage outside of a coverage area 120 of the base station 105. Thus communication by relay station 3 115-3 can include communication for subscriber station 7 110-7; and communication by relay station 4 115-4 can include communication for subscriber station 6 110-6, which otherwise would not be possible directly to the base station 105.

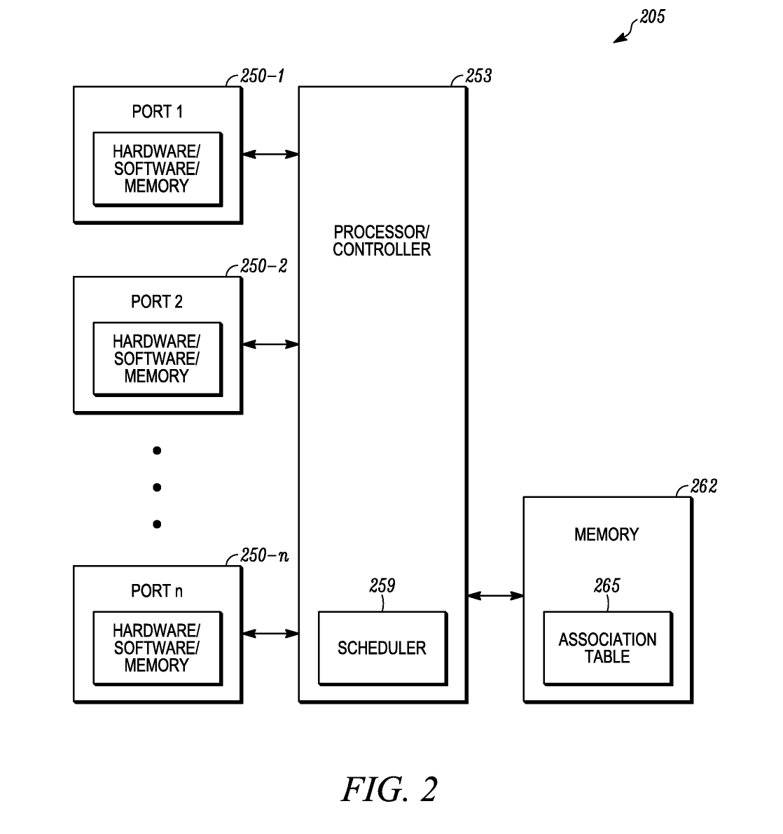

FIG. 2 illustrates an exemplary base station 205 in accordance with some embodiments of the present invention. As illustrated, the base station 205 comprises a plurality of ports 250-n, a controller 253, and a memory 262.

Each port 250-n provides an endpoint or “channel” for network communications by the base station 205. Each port 250-n may be designated for use as, for example, an IEEE 802.16 port or a backhaul port or an alternate backhaul port. For example, the base station 205 can communicate with one or more relay stations and/or one or more subscriber stations within an 802.16 network using an IEEE 802.16 port. An IEEE 802.16 port, for example, can be used to transmit and receive both data and management information.

A backhaul port similarly can provide an endpoint or channel for backhaul communications by the base station 205. For example, the base station 205 can communicate with one or more other base stations using the backhaul, which can be wired or wireless, via the backhaul port.

Each of the ports 250-n are coupled to the controller 253 for operation of the base station 205. Each of the ports employs conventional demodulation and modulation techniques for receiving and transmitting communication signals respectively, such as packetized signals, to and from the base station 205 under the control of the controller 253. The packetized data signals can include, for example, voice, data or multimedia information, and packetized control signals, including node update information.

The controller 253 includes a scheduler block 259. The scheduler block 259 and the parameters utilized therein can be hard coded or programmed into the base station 205 during manufacturing, can be programmed over-the-air upon customer subscription, or can be a downloadable application. Other programming methods can be utilized for programming the scheduler block 259 into the base station 205. The scheduler block 259 can be hardware circuitry within the base station. The scheduler block 259 can be contained within the controller 253 as illustrated, or alternatively can be an individual block operatively coupled to the controller 253 (not shown).

To perform the necessary functions of the base station 205, the controller 253 is coupled to the memory 262, which preferably includes a random access memory (RAM), a read-only memory (ROM), an electrically erasable programmable read-only memory (EEPROM), and flash memory. The memory 262 includes storage locations for the storage of an association table 265.

The memory 262 can be integrated within the base station 205, or alternatively, can be at least partially contained within an external memory such as a memory storage device. The memory storage device, for example, can be a subscriber identification module (SIM) card.

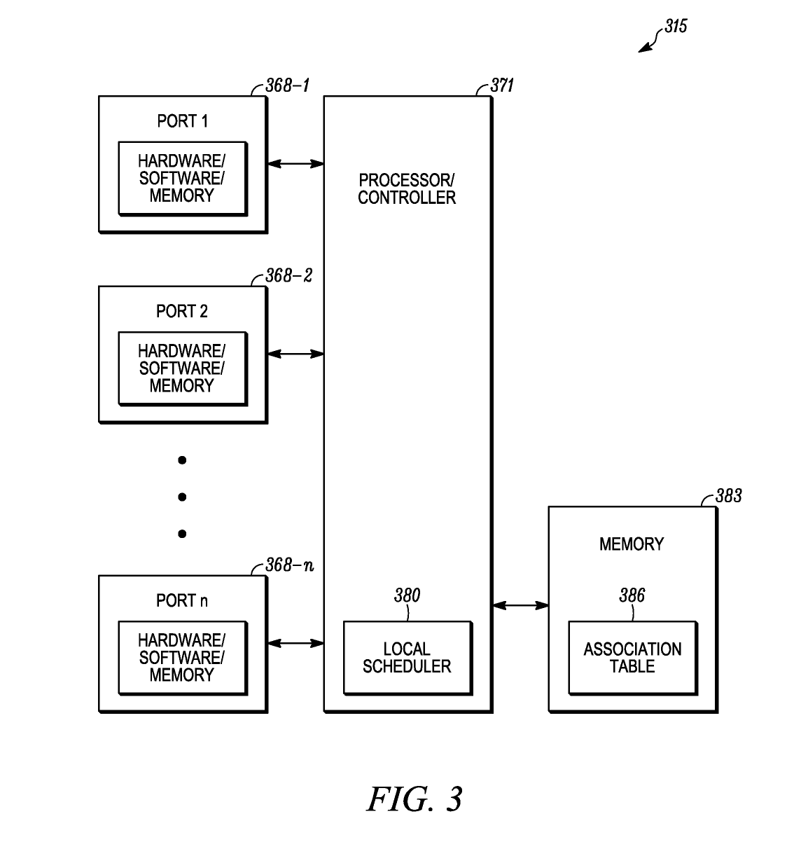

FIG. 3 illustrates an exemplary relay station 315 in accordance with some embodiments of the present invention. As illustrated, the relay station 315 comprises a plurality of ports 368-n. Each port 350-n may be designated for use as, for example, an IEEE 802.16 port or a backhaul port or an alternate backhaul port. For example, the plurality of ports 368-n can include an IEEE 802.16 port, which is used to communicate with one or more base stations, one or more relay stations and/or one or more subscriber stations. The relay station 315 further comprises a controller 371 and a memory 383.

An IEEE 802.16 port, for example, provides an endpoint or “channel” for 802.16 network communications by the relay station 315. For example, the relay station 315 can communicate with one or more base stations and/or one or more relay stations and/or one or more subscriber stations within an 802.16 network using the IEEE 802.16 port. An IEEE 802.16 port, for example, can be used to transmit and receive both data and management information.

Each of the ports 368-n are coupled to the controller 371 for operation of the relay station 315. Each of the ports employs conventional demodulation and modulation techniques for receiving and transmitting communication signals respectively, such as packetized signals, to and from the relay station 315 under the control of the controller 371. The packetized data signals can include, for example, voice, data or multimedia information, and packetized control signals, including node update information.

The controller 371 includes a local scheduler 380. The local scheduler 380 and the parameters utilized therein can be hard coded or programmed into the relay station 315 during manufacturing, can be programmed over-the-air upon customer subscription, or can be a downloadable application. Other programming methods can be utilized for programming the local scheduler 380 into the relay station 400. The local scheduler 380 can be contained within the controller 371 as illustrated, or alternatively can be individual blocks operatively coupled to the controller 371 (not shown). The operation of each of these blocks will be described herein.

To perform the necessary functions of the relay station 315, the controller 371 and the local scheduler 380 are each coupled to the memory 383, which preferably includes a random access memory (RAM), a read-only memory (ROM), an electrically erasable programmable read-only memory (EEPROM), and flash memory. The memory 383 includes storage locations for the storage of a neighbor table 386.

The memory 383 can be integrated within the relay station 315, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the relay station 315.

In typical systems such as the network 100, IEEE 802.16 base stations do not forward traffic to other base stations on the IEEE 802.16 air interface. Further, IEEE 802.16 relay station can forward traffic to base stations, relay stations, or subscriber stations. As previously mentioned, the relay stations are themselves managed/controlled by at least one of the base stations. Further relay stations can be fixed, nomadic or mobile.

Referring again to FIG. 1, the links shown using a dotted line (e.g., the links between the base station 105 and subscriber stations 110-1, 110-2) represent links characterized by a low Carrier Interference-to-Noise Ratio (CINR), whereas all other links shown using a solid line represent links characterized by a high Carrier Interference-to-Noise Ratio (CINR).

The high Carrier Interference-to-Noise Ratio (CINR) links shown as solid lines, for example, between the base station 105 and the relays stations 115-1, 115-2 and between the relays stations 115-1, 115-2 and the subscriber stations 110-1, 110-2, support relatively high data rates and are suited for communicating user data and/or control information. For example, the base station 105 directly serves SS3 110-3, and relay stations RS1-RS3 via high CINR links. In addition, the relay station 115-3 directly serves subscriber stations SS5 110-5 and SS7 110-7 via high CINR links (shown with solid-line arrows), and the relay station 115-4 serves subscriber stations 110-4 and 110-6 via high CINR links (also shown with solid-line arrows). As used herein, the term “user data” can refer to, for example, data generated by applications, a network management entity, or any other higher-layer or peer-layer protocol entities that may use the IEEE 802.16 Media Access Control (MAC) layer to transfer information. Examples of user data include, for example, packets generated by voice, video, e-mail, file transfer applications and network management agents. As used herein, the term “control information” can refer to, for example, messages and signaling used by the IEEE 802.16 MAC layer and physical (PHY) layer to carry out its own protocol functionality. Control information includes periodic control information and aperiodic control information. As used herein, the term “periodic control information” can refer to, for example, preambles, midables, synchronization sequences, timing and frequency correction channels or any other signaling used to ensure correct reception of the messages transmitted in a frame. Examples of periodic control information include, for example, frame control information such as a frame control header (FCH), a synchronization channel, preamble information, information regarding the frame structure, markers which flag the start of the frame, a downlink MAP (DL-MAP) message and other types of control information. As used herein, the term “aperiodic control information” can refer to, for example, messages transmitted aperiodically to ensure proper protocol behavior and station upkeep. Examples of aperiodic control information include, for example, management and control information, such as capability announcements, ranging messages, measurement reports, and handoff instructions.

The base station 105 maintains low CINR links (shown with dotted-line arrows) to the subscriber stations (SS1) 110-1, (SS2) 110-2. The low Carrier Interference-to-Noise Ratio (CINR) links shown using dotted lines, for example, between the base station 105 and the subscriber stations (SS1) 110-1, (SS2) 110-2 support relatively low data rates and are better suited for communicating control information between the base station 105 to the subscriber stations 110-1, 110-2. Although user data can be communicated over the low CINR link, transmitting user data over the low CINR links can be inefficient since the data rate on such links is relatively low in comparison to the data rates supported by the high CINR links.

Depending on what coverage footprint a particular relay station is expected to serve, the particular relay station may or may not need to relay or retransmit control information it receives from the base station 105. For instance, with respect to the exemplary network shown in FIG. 1, relay station (RS3) 115-3 and relay station (RS4) 115-4 need to transmit downlink control information to their associated nodes which are outside the coverage area of base station 105 and cannot communicate directly with the base station 105. For example, relay station (RS3) 115-3 and relay station (RS4) 115-4 serve subscriber stations SS7 110-7 and SS6 110-6 which are outside the communication range of base station 105. By contrast, relay station (RS1) 115-1 and relay station (RS2) 115-2 need not relay or retransmit downlink control information since each of the subscriber stations SS1 110-1 and SS2 110-2 associated with those relay stations are within the coverage area of base station 105 and can communicate directly with the base station 105.

Besides relaying or retransmitting control information, relay station (RS3) 115-3 and relay station (RS4) 115-4 also relay or repeat any instructions/control/management messages that the base station 105 might send to subscriber stations (SS4-SS7) 110-4 and 110-7 being served by the relay stations (RS3) 115-3, (RS4) 115-4. The base station 105 may opt to send such messages directly to subscriber stations SS1 110-1 and SS2 110-2 using lower modulation and coding scheme (MCS) and rely on relay station (RS1) 115-1 and relay station (RS2) 115-2 to relay user data using a higher MCS. In such “transparent relay” scenarios, subscriber stations SS1 110-1 and SS2 110-2 may not even be aware of the presence of relay stations or the services they provide.

### Exemplary Network Having a Mobile Relay Station (MRS)

In some implementations, mobile relay stations (MRSs) will be deployed on mobile platforms such as vehicles (e.g., automobiles, aircraft, watercraft, trains).

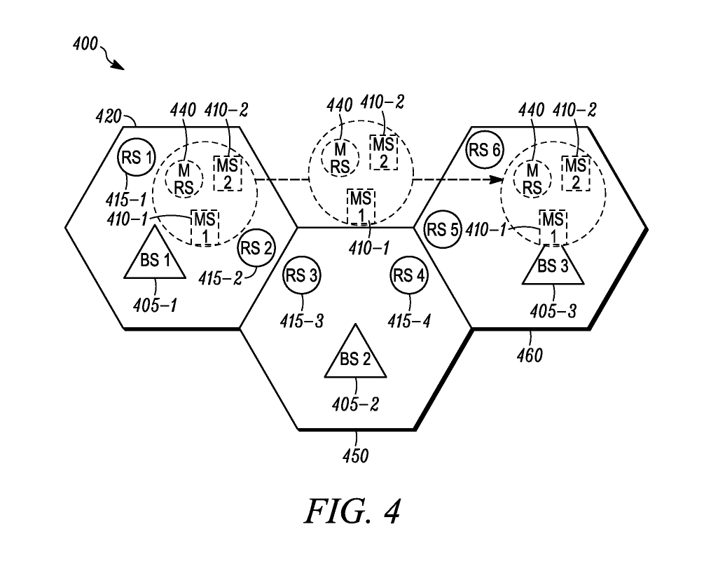

FIG. 4 is a block diagram of an exemplary ad hoc communication network 400 which comprises a plurality of multihop cells (MHCs) 420, 450, 460, and a mobile relay station (MRS) 440. In one exemplary implementation, the communication network 400 complies with the IEEE 802.16j standard.

Multihop cell 420 comprises a base station (BS1) 405-1, a fixed relay station (RS1) 415-1, and a fixed relay station (RS2) 415-2. Similarly, multihop cell 450 comprises a base station (BS2) 405-2, a fixed relay station (RS3) 415-3, and a fixed relay station (RS4) 415-4. In addition, multihop cell 460 comprises a base station (BS3) 405-3, a fixed relay station (RS5) 415-5, and a fixed relay station (RS6) 415-6. Each of the MHCs 420, 450, 460 are defined by a coverage area of their respective base stations 405-1, 405-2, 405-3. While depicted as having a hexagonal coverage area, it will be appreciated that in reality, the coverage area of each cell is substantially elliptical (e.g., circular) since the base stations radiate communications signals in a substantially equal manner in all directions.

Base stations (BS1, BS2, BS3) 405-1, 405-2, 405-3 are typically coupled to a wired network (not shown) and can provide one or more sources of audio, video and/or data information. Base stations (BS1, BS2, BS3) 405-1, 405-2, 405-3 may be, for example, a cellular base station or other wireless access point. In this particular network 400, each of the base stations (BS1, BS2, BS3) 405-1, 405-2, 405-3 can implement centralized routing and scheduling algorithms. Each of the base stations (BS1, BS2, BS3) 405-1, 405-2, 405-3 is responsible for frame time allocations throughout its respective “multihop cell” (comprising all its relay stations (RSs) and subscriber stations (SSs) communicatively associated with them). Each of the base stations (BS1, BS2, BS3) 405-1, 405-2, 405-3 is responsible for making routing decisions for the different multihop network entities in the network.

Fixed relays stations (RS1-RS6) 415-1, 415-2, 415-3, 415-4, 415-5, 415-6 provide range extension and coverage or capacity improvements. The incorporation of relay stations (RSs) in an IEEE 802.16 network transforms it into a multihop network with each node having one or more options to access a network, such as the Internet, via a base station (BS) 405-1, 405-2, 405-3. In addition, relay stations (RSs) 415-1, 415-2, 415-3, 415-4, 415-5, 415-6 themselves can have one or more available path options to connect to a base station (BS).

Mobile relay station 440 has two mobile stations or nodes 410-1, 410-2 (also referred to herein as subscriber stations) which remain within its proximity while the mobile relay station 440 moves throughout the network (e.g., nodes 410-1, 410-2 move along with mobile relay station 440). In the particular example shown in FIG. 4, the mobile relay station 440 is initially located in the coverage area of cell 420 at a first time, moves between the cells at a second time, and moves into the coverage area of cell 460 at a third time. In other words, the mobile relay station 440 moves from the coverage area of base station1 405-1 to the coverage area of base station3 405-3. In the middle part of the trajectory of the mobile relay station 440, the mobile relay station 440 is outside of the planned cell of any base station, however, the mobile relay station 440 might maintain connectivity with a base station or a relay station (even when out of the cell) via high gain antennas.

As the mobile relay station 440 moves through each of these locations, the mobile relay station 440 can connect to the corresponding base station 405-1, 405-2, 405-3 either directly or via one or more neighbor relay stations 415-1, 415-2, 415-3, 415-4, 415-5, 415-6. Moreover, the nodes 410-1, 410-2 or subscriber stations (SSs) may gain network access via one or more neighbor relay stations (RSs) 415-1, 415-2, 415-3, 415-4, 415-5, 415-6 and/or one or more neighbor base stations (BSs) 405-1, 405-2, 405-3.

As such, the mobile relay station 440 can experience frequent topology changes when the environment or network topology around a mobile relay station 440 changes. If most topology decisions are to be made centrally at the base station 405-n, topology related control traffic itself will contribute a significant burden on the base station scheduler. Thus, because mobile relay stations in the multihop network will be involved in significant number of topology changes, large amounts of topology change information will be generated and sent to the base station. The mobile relay stations will likewise receive topology related instructions from the base station. Thus, additional (and in some cases duplicative) control traffic will be generated and transferred between the base station and the mobile relay station 440.

### Overview

In comparison to a base station, a relay station can have a significantly smaller portion of the frame available for services which the relay station offers. Broadcasts of periodic control information occupy the same amount of frame time regardless of whether the periodic control information is being transmitted by the base station or being relayed or retransmitted by the relay station. As such, retransmission of periodic downlink control information by a relay station can consume a significant part of the relay station frame. In addition, these periodic transmissions cause significant power drainage in portable and mobile relay stations. Moreover, other aperiodic control messages sent from the base station to subscriber stations via the relay station also have to be relayed or retransmitted thereby consuming a significant portion of the relay station's resources.

The present invention provides techniques for improving broadcast efficiency in a multihop network comprising a base station which transmits a downlink signal, at least one relay station and at least one node associated with the relay station. For example, in one implementation, the relay station relays or retransmits the downlink signal it receives from the base station to nodes associated with the relay station. The base station monitors downlink transmission metrics provided by the each of the nodes associated with the relay station. Each downlink transmission metric provides a measure of the downlink signal received by a particular node from the base station. Based on the downlink transmission metrics, the base station decides if the relay station should continue to relay or retransmit the downlink signal to the nodes associated with the relay station.

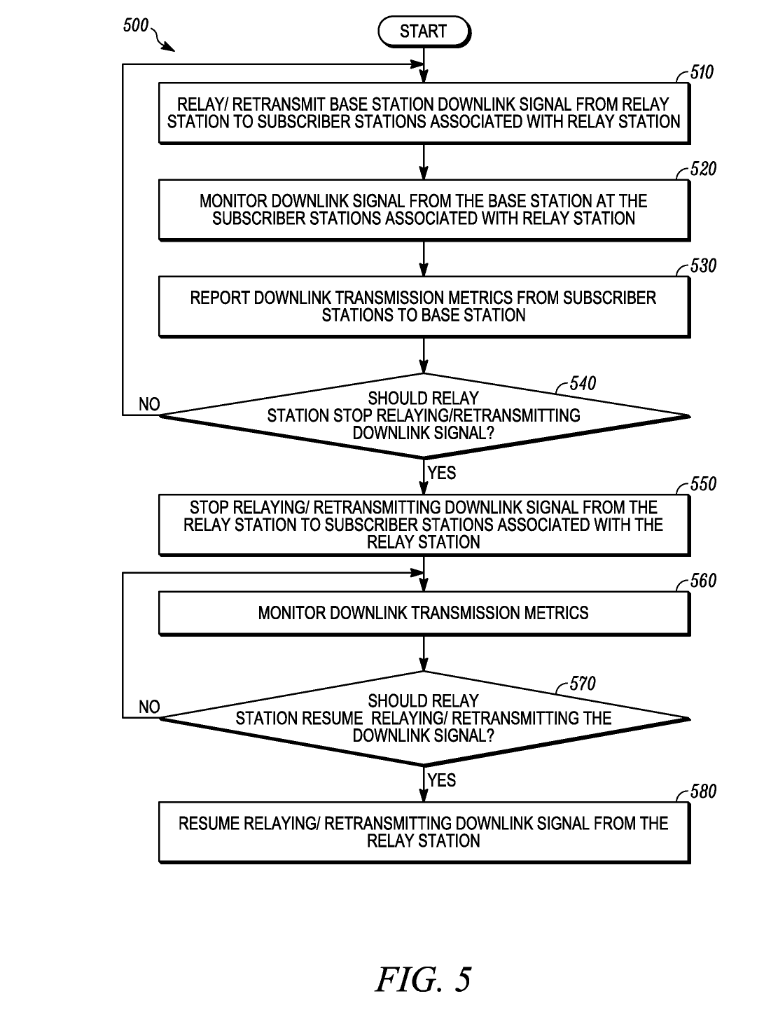

These techniques can help to reduce or eliminate duplicate re-transmissions of periodic control information to the subscriber stations by the base station and/or by the relay stations. These techniques will now be described with reference to FIGS. 5-8.

FIG. 5 is a flowchart illustrating an exemplary method 500 for improving broadcast efficiency in a multihop network in accordance with some embodiments of the invention. The multihop network comprises at least one base station, at least one relay station and at least one node associated with the relay station.

In conjunction with the method 500, the base station transmits information via a downlink signal to the relay station and the nodes associated with the relay station. In one embodiment, the information transmitted in the downlink signal comprises periodic control information sent by the base station to the relay station and its associated nodes. In addition, the relay station can also transmit its own downlink signal (e.g., a downlink signal which originates at the relay station). When the method 500 starts at step 510, the relay station is “active” meaning that the relay station is retransmitting or re-broadcasting information in the downlink signal from the base station to subscriber stations and/or other relay stations which are within communication range of the relay station. In other words, the base station is communicating with at least some of the associated nodes through the relay station. The “associated nodes” can be subscriber stations and/or other relay stations associated with the relay station.

At step 520, the relay station monitors at least one downlink transmission metric that is provided by the each of the associated nodes. Each downlink transmission metric provides a measure or indication of the downlink signal that is received by a particular node from the base station. The downlink transmission metric of the downlink signal can help to provide an indication of the quality of the link between the base station and a particular one of nodes that is currently associated with the relay station. For instance, in one embodiment, each downlink transmission metric comprises an indication of the reception quality of the downlink signal as measured at a particular one of the associated nodes. Examples of downlink transmission metrics can include, for example, Carrier Interference-to-Noise Ratio (CINR) CINR, received signal strength indication (RSSI) which is a measure of the received radio signal strength, throughput, data rate, delay, power consumption or combinations thereof or other generic radio receiver technology metric.

At step 530, the relay station compiles the downlink transmission metric(s) received from each of the nodes (or at least one of the nodes), and generates a downlink report which is sent to the base station. The downlink report reports the downlink transmission metric(s) from each of the nodes associated with the relay station.

At step 540, the base station decides, based on the downlink transmission metrics specified in the downlink report, whether the relay station is to continue relaying or retransmitting the downlink signal (or to continue relaying or retransmitting the periodic control information in the downlink signal) to the associated nodes.

When the base station decides that the relay station is to continue retransmissions of the downlink signal (or periodic control information in the downlink signal) to its associated nodes, then the method 500 loops back to step 510.

When the base station decides that the relay station is to stop retransmissions of the downlink signal (or periodic control information in the downlink signal) to its associated nodes, then at step 550 the relay station stops retransmission of the downlink signal (or periodic control information in the downlink signal) to its associated nodes. In some implementations, the relay station can also stop transmitting its own downlink signal (e.g., a downlink signal which originates at the relay station).

Once the relay station exits its active state, in some cases the relay station can later become active, for example, when the topology of the network changes. Steps 560 through 580 describe techniques used by the base station and the relay station to determine whether the relay station is to resume relaying or retransmitting the downlink signal provided from the base station.

At step 560, the base station monitors at least one downlink transmission metric of the downlink signal that is provided from the relay station. The relay station provides the downlink transmission metric of the downlink signal to the base station. However, the downlink transmission metric of the downlink signal can be a measurement made by a node or nodes associated with the relay station (and provided from the relay station to the base station) or can be a measurement made directly by the relay station itself Alternatively, the base station can directly measure transmission on the uplink from the subscriber stations associated with the relay station.

At step 570, the base station determines, based on the downlink transmission metric that is provided from the relay station at step 560, when the relay station is to resume relaying or retransmitting the downlink signal (or periodic control information in the downlink signal) which it receives from the base station to the nodes currently associated with the relay station (or to nodes currently within the transmission range of the relay station). When the base station determines that the relay station should remain passive and not resume retransmitting the downlink signal (or periodic control information in the downlink signal), then the method 500 loops back to step 560 where the base station continues to monitor downlink transmission metric(s).

When the base station determines that the relay station is to become active and resume relaying or retransmitting the downlink signal (or periodic control information in the downlink signal), then the method 500 proceeds to step 580 where the relay station resumes relaying or retransmitting the downlink signal (or periodic control information in the downlink signal). In some implementations, the relay station can also resume transmitting its own downlink signal (e.g., a downlink signal which originates at the relay station).

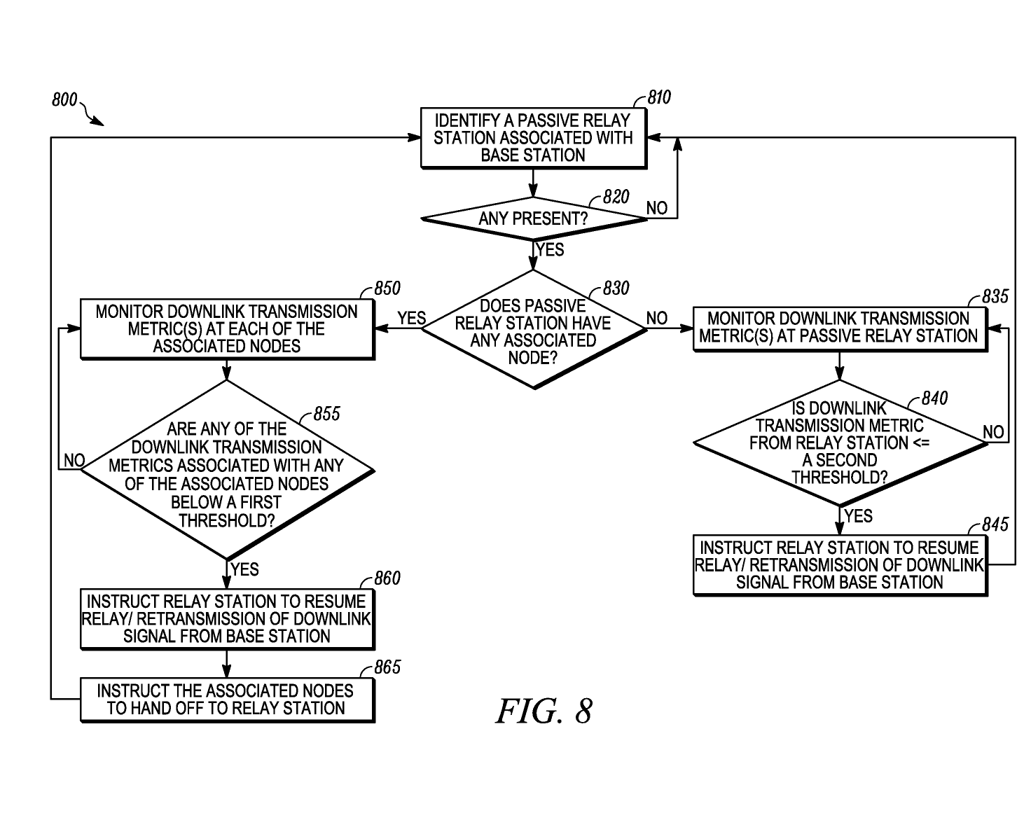

One implementation of the techniques used to determine whether the relay station is to resume relaying or retransmitting the downlink signal provided from the base station (e.g., steps 560 through 580) will be described below with reference to FIG. 8.

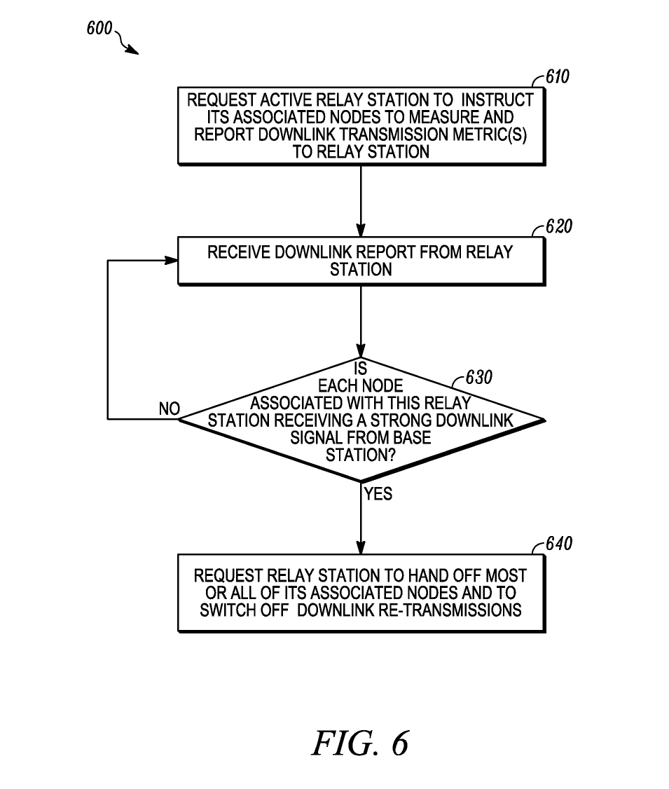

FIG. 6 is a flowchart illustrating an exemplary method 600 for operating a base station within the multihop network to improve broadcast efficiency in the multihop network in accordance with some embodiments of the invention. The method 600 can enable a relay station to avoid transmitting, for example, periodic downlink broadcasts.

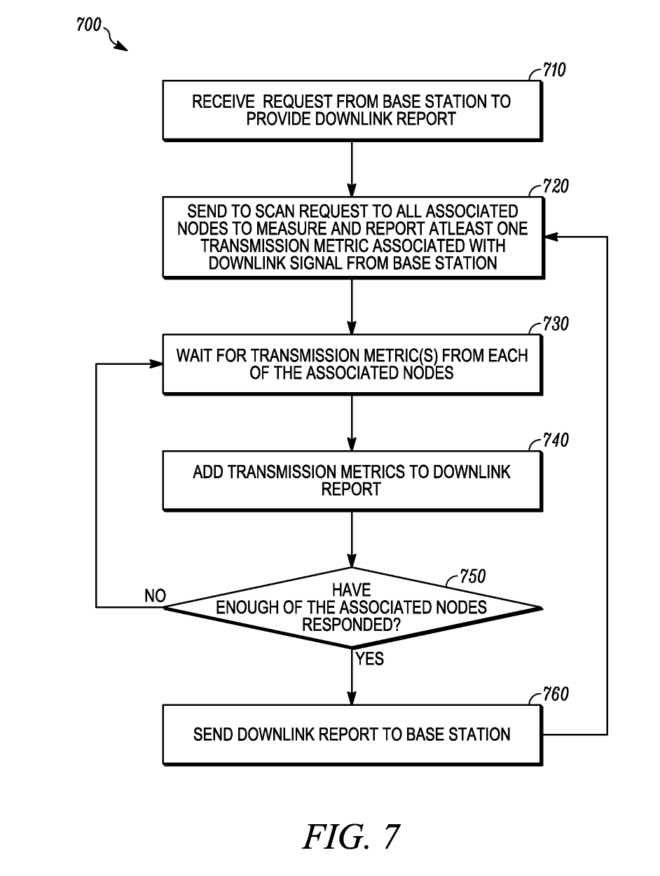

At step 610, the base station transmits a request to the active relay station for a downlink report. This request instructs the active relay station to send a request to its associated nodes to measure a signal received from the base station and/or other station(s) or node(s) and report at least one downlink transmission metric (and possibly a number of downlink transmission metric) measured by the associated nodes to the active relay node. Alternatively, the active relay station can generate a downlink report on a regular basis and send the download report to the base station without the base station explicitly requesting the downlink report. In either implementation, the active relay station eventually generates and sends the downlink report to the base station. One exemplary method for generating the downlink report will be described in detail below with reference to FIG. 7.

At step 620, the base station receives the downlink report from the relay station to the base station. The downlink report comprises the downlink transmission metric(s) from each of the nodes associated with the relay station.

At step 630, based on the downlink report received from the relay station, the base station determines whether the downlink transmission metrics provided by the associated nodes reflect that most or all of the associated nodes is receiving a sufficiently strong downlink signal from the base station. This determination can be made by comparing the downlink transmission metrics to a first threshold which defines a level of the same type of metric used for the downlink transmission metric. It will be appreciated that depending on the particular metric(s) being utilized to make this determination, a downlink transmission metric which is above the first threshold can be interpreted as a state in which the relay station should stop transmissions, whereas a downlink transmission metric which is below the first threshold can be interpreted as a state in which the relay station is to resume transmissions. However, if different metric(s) are being utilized to make this determination, a downlink transmission metric which is below the first threshold can be interpreted as a state in which the relay station should stop transmissions, whereas a downlink transmission metric which is above the first threshold can be interpreted as a state in which the relay station is to resume transmissions.

When the base station determines that most of the associated nodes (or in some cases all of the associated nodes) are not receiving a sufficiently strong downlink signal from the base station, then the method 600 loops back to step 620.

By contrast, when the base station determines that most of the associated nodes (or in some cases all of the associated nodes) are receiving a sufficiently strong downlink signal from the base station (based on the downlink transmission metrics, using for example mandatory broadcast MCS), then at step 640, the base station sends a stop transmission request to the relay station which instructs the relay station to stop relaying or retransmitting the downlink signal (or the periodic control information in the downlink signal) to the associated nodes.

In addition, the base station can send a handoff request to the relay station which indicates that the nodes associated with the relay station are to handoff from the relay station, and instructs the relay station to handoff most or all of its associated nodes. For example, in one implementation, the relay station can achieve this by sending a Base Station Handoff Request message (MOB_BSHO-REQ) with “HO operation mode” set to 1. In general, the relay station can relay or retransmit the handoff request from the relay station to the nodes associated with the relay station. In one implementation, the handoff request indicates that the nodes associated with the relay station are to handoff from the relay station to the base station, whereas in other implementations, the handoff request indicates that the nodes associated with the relay station are to handoff from the relay station to another entity in the network (e.g., another relay station, another base station other than the one with which the relay station is currently communicating. After receiving the stop transmission request, the relay station may terminate retransmission of the downlink signal (e.g., the periodic downlink broadcast transmissions). In some implementations, the relay station can also stop transmitting its own downlink signal (e.g., a downlink signal which originates at the relay station).

In addition, when the relay station is a mobile relay station, then the base station can decide that the relay station should stop transmitting periodic broadcast control information based on at least one downlink transmission metric of the downlink signal quality as measured by the relay station itself. For instance, if the relay station receives a preamble from the base station (and/or other station(s) or node(s)) which has a CINR over a certain threshold, then the relay station can be instructed to switch off its periodic downlink broadcast control transmissions and switch to transparent relaying using techniques such as that described, for example, in U.S. patent application Ser. No. 11/363,616 filed Feb. 28, 2006, and titled “System And Method For Managing Communication Routing Within A Wireless Multi-Hop Network.”

Once the relay station has stopped relaying or retransmitting the downlink signal (e.g., periodic downlink broadcasts), the base station can assign the subscriber stations to the relay station in a transparent manner using techniques such as that described, for example, in U.S. patent application Ser. No. 11/363,616 filed Feb. 28, 2006, and titled “System And Method For Managing Communication Routing Within A Wireless Multi-Hop Network.” The subscriber station can then receive downlink transmissions (e.g., control information) directly from the base station, while uplink and downlink transmissions of user data occurs through the relay station.

FIG. 7 is a flowchart illustrating an exemplary method 700 for operating a relay station within the multihop network to generate a downlink report in accordance with some embodiments of the invention.

At optional step 710, the relay station receives a request from the base station to provide a downlink report to the base station. Step 710 is optional since the trigger for generating the downlink report does not necessarily need to come from the base station. Rather, in an alternative implementation, the active relay station can generate the downlink report on a regular basis without the base station explicitly requesting the downlink report.

At step 720, the relay station sends a scan request message to the nodes associated with the relay station. The scan request message requests that the associated nodes measure at least one downlink transmission metric for the downlink signal transmitted from the base station, and report the measured downlink transmission metric back to the relay station. In one implementation, the scan request can be a scanning request allocation message (MOB_SCN-REQ) message from the relay station which lists the base station as the scan and association target.

At step 730, the relay station waits for the associated nodes to transmit their respective transmission metrics (or “scan results”) to the relay station.

At step 740, the relay station adds the respective transmission metrics the downlink report. The relay station can create an entry in the downlink report for each of the nodes associated with the relay station, where each entry comprises a node identifier and at least one corresponding downlink transmission metric measurement for that particular node. For instance, in one implementation, the relay station can compile all scan reports in to an “MS DL report” and send this report to the base station. This way both the base station and the relay station learn the quality of the link between the base station and the subscriber stations associated with the relay station.

At step 750, the relay station determines if enough of the nodes associated with the relay station have provided at least one downlink transmission metric measurement to the relay station. The number or percentage of associated nodes which need to respond varies depending on the particular implementation. In some implementations, the relay station can wait until a certain percentage of its associated nodes respond before sending the downlink report to the base station. In other implementations, the relay station can wait until all of its associated nodes respond before sending the downlink report to the base station. In still other implementations, the relay station waits for a certain amount of time for associated nodes to respond before sending the downlink report to the base station. When the relay station determines that enough of the associated nodes have yet to respond, the method 700 loops back to step 730 where the relay station continues to wait for additional associated nodes to respond and provide their respective downlink transmission metric measurement to the relay station.

When the relay station determines that enough of the associated nodes have responded with their downlink transmission metric measurements, then the method 700 proceeds to step 760, where the relay station sends the downlink report to the base station. The downlink report reports the downlink transmission metric measurements associated with each of the nodes associated with the relay station. The downlink transmission metric measurements included in the downlink report can include connection IDs (CIDs) of the associated nodes, service flow quality of service (QoS) parameters of the different CIDs, whether the associated node is a relay station (RS) or a subscriber station (SS), and associated nodes' MAC addresses.

FIG. 8 is a flowchart illustrating an exemplary method 800 for operating a base station and a passive relay station within a multihop network in accordance with some embodiments of the invention. The method 800 can be used to determine whether the passive relay station is to resume relaying or retransmitting the downlink signal from the base station.

At step 810, the base station attempts to identify a passive relay station associated with the base station. At step 820, the base station determines if it has identified a passive relay station associated with the base station. The base station can identify the relay station as being a passive relay station by confirming that the relay station is not currently relaying or retransmitting the downlink signal (or the periodic control information in the downlink signal) to subscriber stations associated with the relay station.

When the base station determines that it has not identified any passive relay station associated with the base station, then the method 800 loop back to step 810.

When the base station determines that it has identified a passive relay station associated with the base station, then at step 830 the base station determines if the passive relay station has any nodes associated with the passive relay station.

When the base station determines that the passive relay station does not currently have any associated nodes, then the method 800 proceeds to step 835. At step 835, the base station can send a request to the passive relay station to provide at least one downlink transmission metric of the downlink signal (or of the periodic control information in the downlink signal). The passive relay station can measure at least one downlink transmission metric of the downlink signal, and send the at least one downlink transmission metric to the base station. The base station can then monitor the at least one downlink transmission metric of the downlink signal (or of the periodic control information in the downlink signal) that is provided from the relay station.

At step 840, the base station can determine if the downlink transmission metric that is received from the relay station is less than or equal to a second threshold. The second threshold can be a predetermined level of the metric, preset by the network operator or dynamically computed by one or more network entities. For example, the second threshold can be a CINR level or an RSSI level. It will be appreciated that depending on the particular metric(s) being utilized to make this determination, a downlink transmission metric which is above the first threshold can be interpreted as a state in which the relay station should stop transmissions, whereas a downlink transmission metric which is below the first threshold can be interpreted as a state in which the relay station is to resume transmissions. However, if different metric(s) are being utilized to make this determination, a downlink transmission metric which is below the first threshold can be interpreted as a state in which the relay station should stop transmissions, whereas a downlink transmission metric which is above the first threshold can be interpreted as a state in which the relay station is to resume transmissions.

When the base station determines that the downlink transmission metric from the relay station is greater than the second threshold, then the method 800 loops back to step 835. When the base station determines that the downlink transmission metric from the relay station is less than or equal to the second threshold, then the method 800 proceeds to step 845 where the base station transmits a first command to the relay station. The first command instructs the relay station to resume relay or retransmission of the downlink signal (or periodic control information in the downlink signal). Once the relay station processes the first command, the relay station resumes relaying or retransmitting the downlink signal (or periodic control information in the downlink signal). In some implementations, the relay station can also resume transmitting its own downlink signal (e.g., a downlink signal which originates at the relay station). Following step 845, the process 800 can then loop back to step 810.

When the base station determines that the passive relay station has nodes associated with the passive relay station, then the method 800 proceeds to step 850. At step 850, the base station monitors downlink transmission metric(s) from each of the nodes using the passive relay station for communication. In other words, when a relay station is “passive,” nodes use the relay station in a transparent manner even though the relay station is not transmitting periodic downlink control information. This passive relay station is merely used to retransmit or repeat user data or bearer traffic. Each downlink transmission metric of the downlink signal (or periodic control information in the downlink signal) provides an indication of the quality of the link between the base station and a particular one of nodes that is currently associated with the passive relay station.

At step 855, the base station determines if any of the downlink transmission metrics from the associated nodes are less than or equal to a first threshold. The first threshold can be a predetermined level of the metric, preset by the network operator or dynamically computed by one or more network entities. For example, the first threshold can be a CINR level or an RSSI level. As above, it will be appreciated that depending on the particular metric(s) being utilized to make this determination, a downlink transmission metric which is above the first threshold can be interpreted as a state in which the relay station should stop transmissions, whereas a downlink transmission metric which is below the first threshold can be interpreted as a state in which the relay station is to resume transmissions. However, if different metric(s) are being utilized to make this determination, a downlink transmission metric which is below the first threshold can be interpreted as a state in which the relay station should stop transmissions, whereas a downlink transmission metric which is above the first threshold can be interpreted as a state in which the relay station is to resume transmissions.

When the base station determines that the downlink transmission metrics from the associated nodes are greater than the second threshold, then the method 800 loops back to step 850 where the base station continues to monitor downlink transmission metric(s) from each of the nodes associated with the passive relay station.

When the base station determines that any of the downlink transmission metrics from the associated nodes are less than or equal to the second threshold, then the method 800 proceeds to step 860, where the base station can transmit a second command to the relay station. The second command instructs the relay station to resume retransmission of the downlink signal (or periodic control information in the downlink signal) to its associated nodes. The relay station processes the second command and then resumes relaying or retransmitting the downlink signal (or periodic control information in the downlink signal) to its associated nodes. In some implementations, the relay station can also resume transmitting its own downlink signal (e.g., a downlink signal which originates at the relay station).

At step 865, the base station also instructs the associated nodes to handoff to the relay station such that the nodes associated with the relay station can receive the downlink signal (or periodic control information in the downlink signal) that is relayed or retransmitted from the relay station. Following step 865, the process 800 can then loop back to step 810.

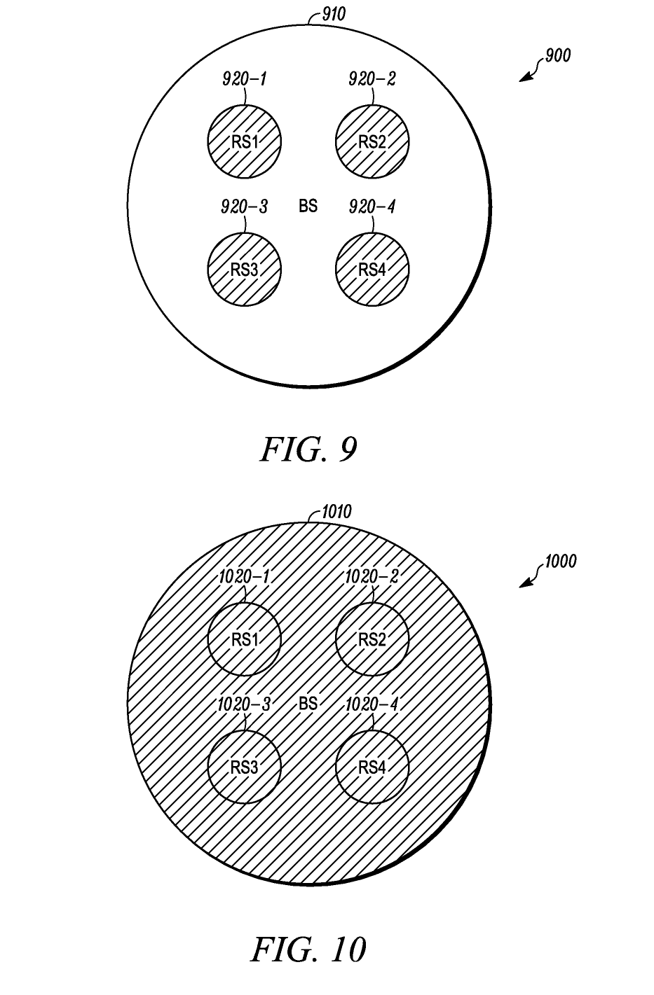

FIG. 9 is a block diagram of an exemplary communication network 900 which illustrates a coverage footprint 910 of a base station operating at a first frequency and coverage footprints 920 of relay stations which are within the coverage footprint 910 of the base station and operating at a second frequency. In FIG. 9 the relay stations operate at a different frequency than the base stations to provide enhanced capacity in the network. The coverage footprints of the base station and relay stations can be overlaid so that when extra capacity is required (and extra RF channels are allocable), the base station may use one radio frequency (RF) channel and the relay stations may use a different frequency channel in their footprints. The relay stations can relay or retransmit control information from the base station to subscriber stations within their respective coverage footprints.

FIG. 10 is a block diagram of the exemplary communication network 900 of FIG. 9 which illustrates that the base station and the relay stations are both operating at the second frequency. When an extra RF channel is unavailable, the base station can switch to the same frequency as the relay stations. For example, when the amount of network traffic is reduced, the base station can switch its operating frequency to the same operating frequency used by the relay stations, and instruct the relay stations to stop retransmitting or relaying control information from the base station to subscriber stations within their respective coverage footprints. Under such circumstances, there is great capacity benefit in reducing redundant broadcasts from the relay stations.

The base station can evaluate whether there is a need for the relay stations to transmit control information and periodic downlink broadcasts. When the base station is operating on the same channel as the relay stations that have their coverage footprint overlaid by the base station coverage footprint, the base station instructs the relay stations to stop relaying the control information and stop transmitting the periodic downlink control broadcasts.

In the foregoing specification, specific embodiments of the present invention have been described. However, one of ordinary skill in the art appreciates that various modifications and changes can be made without departing from the scope of the present invention as set forth in the claims below.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. In a multihop network comprising a base station which transmits a first downlink signal, at least one relay station and at least one node associated with the relay station, a method comprising:
retransmitting the first downlink signal from the relay station to nodes associated with the relay station;
monitoring, at the base station, one or more downlink transmission metrics provided by each of the nodes associated with the relay station, wherein each downlink transmission metric provides a measure of the first downlink signal received by a particular node from the base station; and
deciding, at the base station based on the downlink transmission metrics provided by the nodes associated with the relay station, if the relay station is to continue retransmitting the first downlink signal to the nodes associated with the relay station.

2. A method according to claim 1, further comprising:
stopping retransmission of the first downlink signal from the relay station to nodes associated with the relay station when the base station decides that the relay station is to stop retransmissions of the first downlink signal to the nodes associated with the relay station.

3. A method according to claim 1, further comprising:
providing a downlink report from the relay station to the base station, wherein the downlink report reports the downlink transmission metric from each of the nodes associated with the relay station.

4. A method according to claim 1, wherein deciding, at the base station based on the downlink transmission metrics provided by the nodes associated with the relay station, if the relay station is to stop retransmitting the first downlink signal to the nodes associated with the relay station, further comprises:
determining, at the base station, based on the downlink report received from the relay station, if most of the nodes associated with the relay station are receiving the first downlink signal from the base station above a first threshold.

5. A method according to claim 2, wherein the base station decides that the relay station is to stop retransmitting the first downlink signal to the nodes associated with the relay station if most of the nodes associated with the relay station are receiving the first downlink signal from the base station above the first threshold.

6. A method according to claim 2, wherein the base station decides that the relay station is to stop retransmitting the first downlink signal to the nodes associated with the relay station if the relay station is receiving the first downlink signal from the base station and reports that at least one downlink transmission metric of the first downlink signal quality as measured by the relay station is above the first threshold.

7. A method according to claim 5, wherein stopping retransmission of first downlink signal from the relay station to nodes associated with the relay station further comprises:
transmitting a handoff request from the base station to the relay station, wherein the handoff request indicates that the nodes associated with the relay station are to handoff from the relay station;
retransmitting the handoff request from the relay station to the nodes associated with the relay station; and
stopping transmission of the first downlink signal from the relay station to the nodes associated with the relay station.

8. A method according to claim 7, wherein the handoff request indicates that the nodes associated with the relay station are to handoff from the relay station to the base station

9. A method according to claim 1, wherein each downlink transmission metric comprises an indication of the reception quality of a signal from the base station as measured at a particular one of the nodes associated with the relay station.

10. A method according to claim 1, wherein the first downlink signal comprises one or more periodic control information.

11. A method according to claim 3, wherein providing the downlink report from the relay station to the base station, further comprises:
transmitting a scan request message from the relay node to the nodes associated with the relay station, wherein the scan request message requests the nodes associated with the relay station measure at least one downlink transmission metric of the first downlink signal from the base station;
measuring, at the nodes associated with the relay station, a downlink transmission metric of the first downlink signal from the base station;
transmitting at least one downlink transmission metric measurement to the relay station from each of the nodes associated with the relay station;
creating an entry in the downlink report for each of the nodes associated with the relay station, wherein each entry comprises a node identifier and at least one corresponding downlink transmission metric measurement for that node;
determining if each of the nodes associated with the relay station have provided at least one downlink transmission metric measurement to the relay station; and
transmitting the downlink report from the relay station to the base station, wherein the downlink report reports the downlink transmission metric measurements associated with each of the nodes associated with the relay station.

12. A method according to claim 2, further comprising:
identifying, at the base station, the relay station;
confirming, at the base station, that the relay station is not currently retransmitting the first downlink signal to one or more subscriber stations associated with the relay station; and
determining, at the base station, if any nodes are currently associated with the relay station.

13. A method according to claim 12, further comprising:
monitoring, at the base station, at least one downlink transmission metric of the first downlink signal that is received at the relay station if there are not any nodes currently associated with the relay station;
determining, at the base station, if the downlink transmission metric measured by the relay station is less than or equal to a first threshold, wherein the downlink transmission metric provides a measure of the first downlink signal received by the relay station from the base station; and
transmitting a first command to the relay station from the base station if the downlink transmission metric that is received from the relay station is less than or equal to the first threshold, wherein the first command instructs the relay station to resume retransmission of the first downlink signal.

14. A method according to claim 13, further comprising:
retransmitting, responsive to the first command, the first downlink signal from the relay station.

15. A method according to claim 12, further comprising:
monitoring, at the base station, a downlink transmission metric of the first downlink signal provided from the nodes using the relay station for communication if there are any nodes currently using the relay station for communication, wherein the downlink transmission metric provides a measure of the first downlink signal received by the nodes from the base station;
determining, at the base station, if any of the downlink transmission metrics from the nodes using the relay station for communication are less than or equal to a second threshold; and
transmitting a second command to the relay station from the base station if any of the downlink transmission metrics from the nodes using the relay station for communication are less than or equal to a second threshold, wherein the second command instructs the relay station to resume retransmission of the first downlink signal to the nodes using the relay station for communication.

16. A method according to claim 15, further comprising:
retransmitting, responsive to the second command, the first downlink signal from the relay station to the nodes associated with the relay station.

17. A method according to claim 16, further comprising:
transmitting a third command from the base station to the nodes associated with the relay station, wherein the third command instructs the nodes associated with the relay station to handoff to the relay station such that the nodes associated with the relay station can receive the first downlink signal retransmitted from the relay station.

18. In a multihop network comprising a base station which transmits a first downlink signal, at least one relay station which transmits a second downlink signal which originates at the at least one relay station, and at least one node associated with the relay station, a method comprising:
transmitting the second downlink signal and retransmitting the first downlink signal from the relay station to nodes associated with the relay station;
monitoring, at the base station, one or more downlink transmission metrics provided by each of the nodes associated with the relay station, wherein each downlink transmission metric provides a measure of the first downlink signal received by a particular node from the base station; and
deciding, at the base station based on the downlink transmission metrics provided by the nodes associated with the relay station, if the relay station is to continue transmitting the second downlink signal and retransmitting the first downlink signal to the nodes associated with the relay station.

19. A method according to claim 18, further comprising:
stopping transmission of the second downlink signal and retransmission of the first downlink signal from the relay station to nodes associated with the relay station when the base station decides that the relay station is to stop transmission of the second downlink signal and retransmissions of the first downlink signal to the nodes associated with the relay station.
